(19) United States
(12) Patent Application Publication
(10) Pub. No.: US 2018/0050481 A1
(43) Pub. Date: Feb. 22, 2018

(54) DEVICE AND METHOD FOR TESTING MATERIALS

(71) Applicant: Dr. Collin GmbH, Ebersberg (DE)

(72) Inventor: Friedrich KASTNER, Grieskirchen (AT)

(73) Assignee: Dr. Collin GmbH, Ebersberg (DE)

(21) Appl. No.: 15/556,668

(22) PCT Filed: Mar. 2, 2016
(86) PCT No.: PCT/EP2016/054458

§ 371 Date: Sep. 22, 2017

(30) Foreign Application Priority Data
Mar. 9, 2015 (AT) A 50182/2015

(51) Int. Cl. B29C 47/92; B29C 47/68

(52) U.S. Cl. CPC B29C 47/92; B29C 47/682; B29C 47/0002; B29C 2947/92019; B29C 2947/92466; B29C 47/683

(57) ABSTRACT

The invention relates to a device and a method for testing materials, and is characterized in that the device comprises application units (2) for interaction modules (1) and an exchange system for the interaction modules, and the device is designed such that the application units (2) automatically feed interaction modules (1) to the exchange system after a control signal and the exchange system is designed to feed the interaction modules to a test position.

The invention relates to a device for testing materials, in particular plastics, by means of measuring units (e.g. filter units).

The invention is particularly suitable for the production of plastics. The term “material” as used below can therefore be construed as meaning “plastics” in particular.

However, the invention may also be used in other sectors which involve working with melts or mixtures. Accordingly, the term “material” may also be understood differently in the context of these sectors, for example in the sense of “metal material” in the case of metal production or in the sense of “active ingredient” or “pharmaceutical substance” in the context of the production of excipients. Other applications would also be conceivable in the field of foodstuffs or in other sectors which involve working with melts, suspensions or emulsions.

In the field of plastics production and processing, a huge variety of plastic materials are used which often vary significantly in terms of purity and quality. A standardized method of determining material characteristics is the filter pressure test, which is governed by DIN EN 13900-5 “Filter Pressure Value Test”, for example.

Using a device known from the prior art for conducting a filter pressure test, a plastic material or a mixture of several plastic materials is placed in the device via a hopper. By means of the device, a plastic that has been melted by an extruder, for example, is pressed through a defined filter module (e.g. a fabric filter or screen) and the increase in pressure upstream of the filter module during the extrusion process is indicative of a defined quantity of material. This then constitutes a measure of the dispersion quality or purity of the material because agglomerates, other non-molten particles and inadequately dispersed fillers, e.g. pigments, are held back in the filter module, which leads to a rise in pressure due to the continual build-up in the filter module.

The disadvantage of the prior art is that measuring instruments (e.g. filters) have to be manually changed after every individual measurement. This means that a great deal of time is needed for a measurement.

The objective of this invention was to address the disadvantages of the prior art and to propose a device and a method by means of which a user is in a position to take different measurements more effectively and rapidly.

This objective is achieved on the basis of a device and a method as specified in the claims.

In particular, the invention relates to the implementation of filter pressure tests, measurements of the viscoelastic behavior of a liquid, optical measurements or corresponding test methods.

When testing the purity of a material melt (e.g. a molten plastic), an exactly defined quantity of a melt is pressed through a filter module having defined parameters whilst simultaneously measuring the pressure of the melt which builds up upstream of the filter module in order to determine the purity of the material. Such a device is also referred to as a “filter pressure test device” and such a method is known as the “filter pressure test method”.

In order to measure the viscoelastic behavior of a fluid, a melt is pressed through an interaction module having a capillary and pressure measurements (and optionally temperature measurements) are taken at the same time. If taking optical measurements, films are often produced, which are then measured using optical measuring methods.

Generally speaking, however, the device proposed by the invention may be used wherever it is of advantage to be able to change filters or other elements rapidly.

The device for testing materials proposed by the invention is designed in particular so that it can be mounted on a system for mixing, conveying or melting materials or comprises this system, and is characterized in that the device comprises a measuring area, application units for interaction modules and an exchange system for interaction modules, and the device is designed such that the application units automatically feed interaction modules to the exchange system after a control signal and the exchange system is designed to feed the interaction modules to the measuring area.

The method for testing materials proposed by the invention comprises the steps:
storing a number of interaction modules in an application unit,
dispensing the interaction modules from the application unit to an exchange system,
feeding the dispensed interaction modules to a measurement position by means of the exchange system,
in particular, establishing a tight connection to the measuring head (e.g. by a pressing action and/or sealing),
feeding the used interaction modules away after taking the measurement by means of the measuring system,
optionally, guiding the interaction module into a dispensing system by means of the exchange system and optionally into a supply container (e.g. a magazine).

The device preferably further comprises a dispensing system for used interaction modules and the exchange system is additionally configured to feed used interaction modules to the dispensing system after a measurement.

In particular, the device is or can be fixedly connected to the material inlet and/or material outlet of the system for mixing or melting materials.

Interaction modules are modules which are actively involved in taking measurements (such as screens for the filter pressure test or capillaries for measuring the viscoelastic behavior of a fluid) and/or modules which are configured to produce an intermediate product needed for the measurement (e.g. slotted nozzles for producing small films for optical measurements). Elements that are used purely as a means of support for substances, for example, are not interaction modules within the meaning of the invention because they are not actively involved in measuring these substances.

Interaction modules preferably also have sensors by means of which measurements can be taken, e.g. chemical indicators or electric sensors co-operating with a power source and a data memory or elements used for wireless data transmission.

Based on one preferred embodiment, the device comprises a control unit which automatically knows which measurement task is about to be performed, feeds the interaction module to the corresponding measuring area and generates and exports an address or code for a data memory.

The measuring area is an area in which the prescribed measurement takes place. Based on one preferred embodiment, the device comprises sensors for measuring properties of the material, and in particular the measurements are such that the interaction modules actively participate in the measuring operation and without the participation of the relevant interaction modules themselves in the measuring operation, no usable measurement data can be obtained. A measuring device is preferably an integral part of a preferred embodiment. However, the device may also be designed to be mounted on a measuring apparatus (e.g. an apparatus used for the filter pressure test, such as described in DE 10150796, for example) and can be functionally connected to the latter.

In particular, the device proposed by the invention further comprises a device for testing fluids comprising a fluid inlet and at least two, preferably three or more, fluid outlets and is characterized in that each of these fluid outlets can be separately connected to the fluid inlet via a multi-way valve which is capable of assuming at least two functionally different positions so that the fluid flows into one of the fluid outlets respectively depending on the position of the multi-way valve. Such a device for testing fluids works extremely well with the device proposed by the invention.

Application units are units which are capable of holding a number of interaction modules and dispensing them one by one in a controlled manner. Depending on the embodiment, the expression “application unit” refers to a supply module containing the interaction modules.

The interaction modules are preferably dispensed in a controlled manner by means of a controlled closing or dispensing mechanism. In the most basic case, an application unit may be a bottomless container, in which the interaction modules are disposed one above the other, and which is mounted above the exchange system so that interaction modules easily drop onto the exchange system. If the application units are disposed at a distance that is slightly bigger than the height of the interaction modules, an interaction module that is in the process of dropping prevents another one from sliding down after it until it is moved away by the changer unit. The next interaction module then drops automatically.

Based on one preferred embodiment, the application units are suitable for accommodating magazines in which several interaction modules may be disposed. This enables the application units to be very easily filled with interaction modules. These magazines may be of a design similar to that of slide magazines but interaction modules are placed in the magazine instead of slides. The magazines may also be already fixedly mounted in the device (in particular in the application unit) and/or constitute a storage device for the application units.

The measuring modules may be stacked in the magazine and ejected by force of gravity, spring action, pneumatic pressure, etc.

The expression “automatically fed” in this context means that interaction modules are moved actively (by moving units) or passively (e.g. by means of gravitation) by a controller and placed in a clearly defined position in which they can be picked up by another system or used for the measuring operation (“measurement position”). In particular, the controller also knows the type of measuring module and hence the measurement task in hand and its evaluation.

Based on one preferred embodiment, the exchange system comprises a holder structure for holding the interaction modules and a motion control system (in particular with electric, mechanical, pneumatic or hydraulic motion control units) for moving the interaction modules. The device also comprises a control unit for controlling the exchange system.

The exchange system is preferably configured to move a belt or a rail containing the interaction modules, in particular linearly (optionally also having switching structures) and/or in a circular motion (in particular in the form of a carousel or turntable). In this respect, it is preferable if the application units are disposed in several concentric positions of application units or in a line one after the other. The exchange system may also be designed to hold interchangeable cartridges containing interaction modules.

Based on one preferred embodiment, the device is configured to dispense individual application units in a defined order so that, depending on the application, an interaction module from one application unit is introduced into the exchange system first of all followed by an interaction module from another application unit.

Based on another preferred embodiment, the device is configured so that the application units can be changed during operation. This change is preferably automatically detected by the system, e.g. by means of sensors, which measure the state of occupancy of places for the application units or preferably detect the dispensing of an interaction module. Accordingly, even if they have only been partially dispensed, the interaction modules are constantly topped up during ongoing operation. The removed/added interaction modules can be identified in particular by means of barcodes, other characters, electronic codes or transponders. In particular, sensors measure the filling level of application units.

Based on one preferred embodiment, the device further comprises a motion control system for the application units, which is configured to enable the application units to be moved from one position to another. This being the case, the application units can be moved to a dispensing position and back out of it (after dispensing an interaction module). This motion control system preferably comprises a holder structure provided in the form of a disk and the application units are moved to the desired position by rotating the disk and optionally moving it in translation (carousel/turntable).

In addition to the structures described above, a preferred exchange system also has a transport system, by means of which interaction modules can be picked up, moved and/or dispensed again. The transport system preferably has elements from the group comprising grippers, electromagnets, rams, conveyor belts, rollers, suckers and fans.

Based on one preferred embodiment, the device comprises a marker unit and is configured to automatically identify the interaction modules and/or the application units, in particular by means of characters, colors (e.g. color codes), barcodes, RFID elements, engraving or other patterns. To this end, the device preferably comprises printers, marker elements, elements for applying adhesive materials, punches or other elements for altering surfaces.

In particular, the device is configured so that the interaction modules (and/or the application units) and/or their markings can be scanned by means of a scanner element and a computer unit equipped with user software (contained in the device in particular) and their position and/or function in the device is ascertained on the basis of this scanned information or their position is stored together with the scanned information in a computer system. This being the case, the marking can be used to produce an unambiguous correlation of the position of an interaction module with its property and/or a specific disposition of interaction modules in the device.

Based on one preferred embodiment, the interaction modules are disposed so that the adjacent interaction modules in one direction (interaction modules adjacent to one another or one above the other) respectively have a lower (or higher) value in terms of one of their properties. This enables a sequence of interaction modules to be set up.

Based on one preferred embodiment, the device additionally comprises a dispensing system, which is configured so that interaction modules that are moved from the exchange system into the dispensing system are automatically fed out of the device. This is preferably achieved by means of special motion control units (corresponding in particular to the aforementioned motion control units) or simply on the basis of gravitational force (e.g. via a chute).

The dispensing system preferably further comprises at least one storage unit for storing the dispensed interaction modules. This offers a simple way of enabling the interaction modules to be subsequently organized using the marker system described above.

Based on one preferred embodiment, the device is preferably provided in the form of a filter pressure test device and/or a metering device and/or a device used to measure the viscoelastic behavior of a fluid.

In one preferred embodiment, the device is configured so that the melt can be fed directly into one of the interaction modules, in particular without an extruder and/or melt pump. As a result, the device is suitable for in-line operation.

Based on another preferred embodiment, an upstream plasticizer unit is connected to the device proposed by the invention (which may be a metering device or “autosampler”). As a result, the device is suitable for off-line operation.

As interaction modules, a preferred filter pressure test device comprises filter modules and a sensor system for measuring pressure (and optionally also for measuring temperature), and the filter modules can be positioned in the flow of the material melt (e.g. molten plastic) and the exchange system together with at least one application unit is configured to change the filter modules automatically. A preferred filter pressure test method using such a device comprises the

steps:
optionally pre-heating a filter module,
automatically introducing a filter module (optionally pre-heated) into the flow of a material melt,
measuring the pressure in the material melt, in particular the increase in pressure upstream of the filter module, whilst extruding a defined quantity of material,
automatically removing the filter module from the material melt,
optionally cooling the filter module,
optionally dispensing the filter module from the device and optionally forwarding it to another system.

Suitable sensor systems are known to the skilled person and include in particular pressure sensors which are positioned such that they are able to measure an increase in pressure upstream of the filter whilst extruding a defined quantity of material.

Preferred filter modules comprise filter holder structures for screens/filters or for groups of screens/filters. Preferred filter modules comprise cartridges in which at least one filter/screen is disposed or the filter modules are provided on belts (e.g. filter or screen belts) and correspond in particular to surfaces on these belts.

Preferred filter modules comprise screens and/or filters or combinations of filters and/or screens. Other preferred filter modules are areas of a screen or filter belt. Preferred filter modules are granulates, perforated surfaces or surfaces comprising threads, belts, yarns and fibers or non-woven materials of minerals, plastics, metals or glass.

The exchange system is preferably configured to move a belt containing the filter modules through the melt flow or is configured to move cartridges into and out of a melt flow.

The filter modules are moved into the measuring area and removed from it by means of the exchange system. To this end, the device comprises an opening which is open for this purpose and is then closed again once a filter module has been inserted. The opening is preferably moved electrically, mechanically, hydraulically or by means of pressurized air. Based on a preferred embodiment, the opening is opened, the holder structures of the exchange system are moved (e.g. by means of chocks and spindle drives), the filter module is moved into position and the opening is closed again.

Also preferred is a set-up with a number of concentric or linear-parallel positions of filter modules. This enables filters/screens and filter packs/screen packs of different thickness to be inserted in an ordered manner.

Based on another preferred embodiment, the filter modules are areas on a belt-shaped screen material or filter material.

Preferred are belts with screen/filter structures from the group comprising woven or knitted screens/filters, glass fiber screens/filters, lasered, calendared or needled screens/filters, metal films provided with orifices, fleeces (e.g. staple fiber fleece) or combinations of the aforementioned structures disposed adjacent to one another and/or one above the other.

Based on one preferred embodiment, the exchange system is configured so that its holder structure is able to accommodate a rolled-up filter module belt in a first position and its motion control system is configured so that it unrolls the belt and guides areas of the belt (on which the filter modules are disposed) through a material flow. The holder system is also configured to pick up the belt again once it has been fed through the material flow and the motion control system is configured to roll up the belt again, optionally after curing, and the device is equipped with an additional cooling module for this purpose in particular.

It is of advantage if the filter module is disposed in a pressure-tight arrangement in its measurement position so that the melt is not able to escape at the sides.

The filter modules (including those provided on belts) preferably have a more dense structure at their edges. Such a structure may be obtained by a denser weave/knit or a specific pattern with a lower density of holes at the edges, for example. Such filter modules enable the tightness of the device to be increased.

Based on a preferred embodiment in this respect, the filter modules are disposed on webs in particular. Due to the different web types, e.g. different degrees of fineness, these filter modules are provided as separate modules or areas on a belt surface lying one after the other and/or next to one another. What is important in this respect is that the screen webs have a denser weave lengthways and widthways at the peripheral regions of the filter modules than at the center of the filter modules, providing a seal to prevent the polymer melt from escaping.

Based on one preferred embodiment, the seal is obtained by means of metal films, resins or other thermoplastic polymers or thermosetting plastics that are resistant to high temperatures, silicones, fluorinated polymers (e.g. Teflon), gasket materials or special papers, and the respective material is applied at or on the peripheral regions of the filter modules.

The layout of filter modules (in particular on a belt) is preferably such that in the peripheral region of the filter module, an edge is provided having a width of 1 mm to 5 cm, in particular a width of between 5 mm and 2 cm, which, in order to improve tightness, has a denser filter/screen structure and/or a is provided with a sealing compound and surrounds a screen/filter region provided for the purpose of taking measurements.

Based on one preferred embodiment, which may be construed as an independent invention in its own right because it describes an alternative to the relatively expensive interaction modules known from the prior art which is less expensive and easier to produce, the interaction modules are produced in the manner described below.

The interaction modules comprise a support and a measuring part which is held and optionally stabilized by this support. The measuring part is that part which is provided as a means of taking the respective measurement. In the case of a filter pressure test, the measuring part is a filter/screen. In the case of taking measurements of the viscoelastic behavior of a fluid, it is a capillary, for example, and if taking measurements relating to optical or haptic properties, it will be a slot for forming a film or a foil, for example.

The support is used to hold the interaction module in the application unit and it can be guided by means of the exchange system, and in particular it is a part produced by injection casting, manufactured in particular from plastic. Naturally, the plastic is selected so that it is suitable for measuring purposes, in particular can withstand the prevailing temperatures and will not be deformed or distort the measurements (e.g. a high-temperature plastic). The support may also be made from metal, ceramic, composite materials or combinations of these materials, e.g. by means of milling, casting or sintering.

In particular, the measuring part is designed so that it is inert for the purpose of the specific measurement to be taken and under the conditions prevailing during the measurement and will therefore not distort the measurement. To this end, it comprises in particular materials from the group including metal, glass, ceramic, plastics (provided they are suitable for the temperatures prevailing during the measurement), carbon and metal oxide. If the support is produced as an injection-molded part and the measuring part comprises materials other than those of the support, the latter is preferably fixed to the support during the manufacturing process by casting or welding. In particular, the materials are placed in a half-piece of the support and then back-injected. For example, combinations of a screen and a metal seal can be produced which are embedded in a support with a plastic holder on the outside by means of assembly injection molding.

In addition, the interaction module preferably comprises a sealing element which establishes a seal between the device housing and interaction module during the measurement. The support is preferably already shaped so that it will afford a seal but it is also preferable to attach an additional seal to the support or fit it in some other way. A sealing ring or gasket might be used for this purpose, in particular made from metal or plastic. In some applications, however, it will already suffice if the support is thicker in shape around the measuring part than at the edges.

The interaction module may also be provided with a marking as part of the manufacturing process, in which case marker elements are inserted or coding structures are formed on the surface of the support in particular. Preferred forms of marking are those mentioned above (e.g. color, ridges, barcode, transponder etc.).

The interaction modules are dispensed from the application unit in particular due to the fact that the support of the measuring unit is provided with molded regions in which metering modules of the application unit are able to locate. These metering modules may be simple hooks or plates which locate in these molded regions to prevent uncontrolled dispensing of the interaction modules.

Based on one preferred embodiment, the interaction modules comprise structures and/or recesses (e.g. grooves and/or tongues) extending out from their side walls and the application units and/or the exchange system have structures and/or recesses extending out from them in order to guide the interaction modules. This ensures a reliable and exact guiding action for the interaction modules in the device.

Based on one preferred embodiment, the device further comprises cleaning modules which are intermingled with the interaction modules or disposed in a separate application unit. The advantage of this is that the device can be easily cleaned.

The cleaning modules are designed in particular so that the region of the interaction modules used for measuring purposes or the entire open cross-section is filled with material (in particular a cleaning material) so that any impurities, e.g. residues of polymer melts, can be removed by the sliding movement. The cleaning materials comprise in particular brushes, blades, scrapers, preferably made from metals, alloys, steel, plastics, fabrics, fleece, wood, glass or other materials.

Based on another preferred embodiment, an interaction module comprises a number of different regions suitable for taking measurements. For example, interaction modules may be equipped with a number of different screens or may have both screens and capillanes or alternatively any other desired openings or molded regions.

Based on one preferred embodiment, the invention comprises a sealing unit in the measuring area which, in order to provide a seal between the interaction module and the measuring area, is designed so that the measured material flow runs in a specific way during the measurement.

The interaction modules can be sealed when in the measurement position in, particular due to the fact that the interaction modules are moved into the measuring position by means of a lifting or screwing motion onto the housing wall of the device, where they are held firmly pressed. Naturally, the seals listed above could also be used to provide a seal, in which case the movement needed to obtain this seal will depend on the corresponding means used.

Another preferred option is one where the sealing unit is moved in order to provide a seal between the interaction module and the measuring area. In this case, it is not the interaction module which is moved but rather the sealing unit.

Using the filter pressure test device, it is possible to take measurements with not just one screen geometry but with several different filter modules one after the other, each being different in terms of its fineness, screen type or screen materials. It is also possible to put together individual screen packs or alternatively take measurements using filter modules containing filter sands (e.g. of minerals, plastics and/or metals) and combinations of all possible materials. Based on such an embodiment enabling filter modules to be changed, not only is it possible to test materials on an automated basis, it is also possible to optimize screens/filters for the respective application. It is possible to work, for example, with belts having thicker weave at the edges or having different weave structures along the length.

In this manner, it is possible to find the right filters for the production process. For example, working with an in-line filter pressure test operated in a side flow, e.g. a production machine or recycling machine, the correct filter geometry can be automatically set up due to the measurements taken in the filter pressure test or if operating with a downstream inline method also in the production or recycling machine in order to obtain optimum material properties.

Based on one preferred embodiment, at least one interaction module is configured to measure the flow properties of a material in order to determine both viscous and elastic flow behavior. To this end, the relevant interaction modules have at least one capillary (“capillary module”) in particular, through which the material is pressed.

Capillaries may have different geometries. Preferred capillary cross-sections are circular, triangular or polygonal or slot-shaped (e.g. rectangular, wedge-shaped or trapezoidshaped). They may be straight, curved or spiral-shaped in transverse profile and/or longitudinal profile. The advantage of a non-straight design is that a longer run can be obtained for a relatively compact shape of the interaction module.

Based on one preferred embodiment, the interaction module or the device is configured to impart a mechanical vibrating motion to the capillary and measure the loss modulus of the vibrations in particular. This enables the elastic/viscous properties of the material to be determined.

A preferred device is one which has filter modules in one application unit and capillary modules in another application unit and by simply controlling the dispensing operation/movement of the application units, different interaction modules can be fed to the exchange system and hence to the measuring operation so that using one and the same device set up in an appropriate configuration and layout of sensors, a filter pressure test can be run in the measuring area at one time and measurements of the viscoelastic behavior of a fluid can be taken at the same measuring point at another time.

Based on another preferred embodiment, the interaction module comprises a slot-shaped, preferably rectangular, opening so that a flat film can be produced.

Based on one preferred embodiment, the device comprises a tempering system which is configured to pre-heat the interaction modules upstream of the measuring area and/or provide cooling downstream of the measuring operation. The interaction modules are preferably cooled after being ejected (e.g. by means of the dispensing system, from which they drop in an ordered manner onto a magazine, for example). This enables the interaction modules to be used for other analysis tasks.

In order to obtain a constant throughput of the molten material, it is preferable to provide a melt pump and/or a measuring system for taking flow measurements (e.g. Coriolis effect on mass flow rate) between the extruder/screw conveyor and interaction module. If using a measuring system to measure flow rate, a correct and constant throughput can be achieved, preferably by regulating the movement of the melt (e.g. the rotation speed of the screw in the extruder).

As an alternative to the melt pump, another option is to use a special melt extruder connected downstream and having a screw geometry that builds pressure.

Another alternative, however, is to provide the screw in the base extruder with appropriate pressure-building geometries in the discharge region, such as special screw pitches for example.

Based on one preferred embodiment, the device is designed so that it is not the entire material flow that is measured and instead, a part of the material flow is branched off and measured. This part is then preferably returned to the material flow. In particular, a sample is drawn off from the region of the conveyor screw or alternatively downstream of the conveyor screw. In this manner, a temporally resolved measurement can be obtained without having to interrupt the production process. In principle, all types of single-screw or multi-screw extruders, compounders and kneaders (co-rotating and counter-rotating, cylindrical and conical geometries) may be used as processing devices. The melt may be directed to a waste container or returned to the main flow via an extruder or melt pump.

However, it may also be preferable to test a melt from a piston container.

It is preferable to provide at least one other measuring unit at the measuring point and connected downstream so that the material measured at the first measuring point is also measured by the at least one other measuring unit, and this at least one other measuring unit is equipped with a device as proposed by the invention in exactly same way as the first one, in particular.

In principle, the device may also be used on a plasticizer unit of an injection casting machine.

Examples of preferred embodiments of the device proposed by the invention are illustrated in the appended drawings.

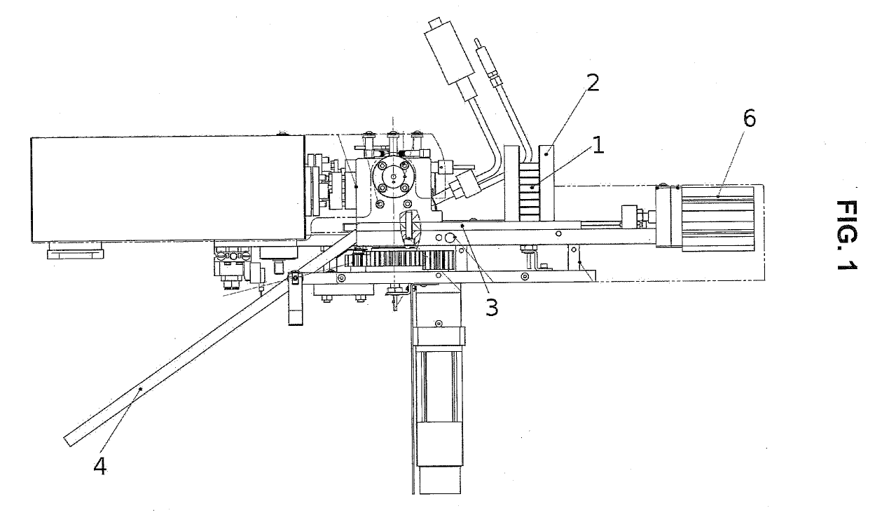

FIG. 1 is a side view schematically illustrating a preferred embodiment;

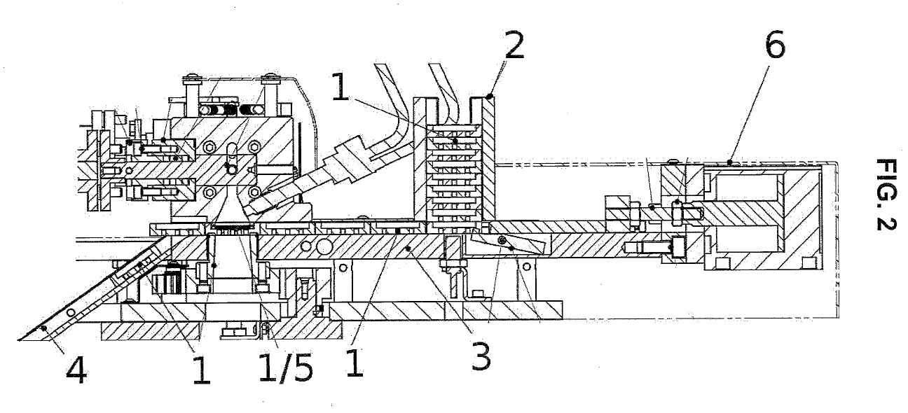

FIG. 2 is a side view illustrating a view in section of this embodiment;

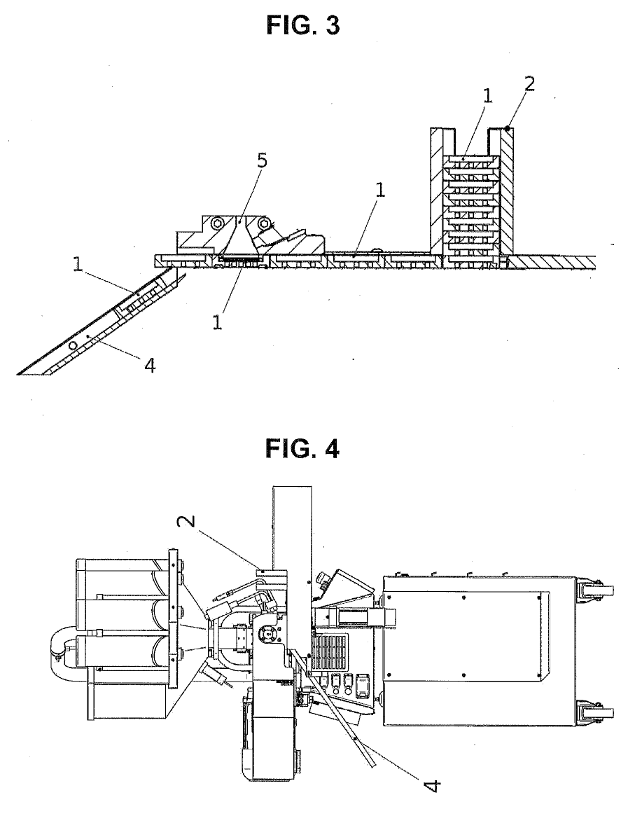

FIG. 3 is a side view illustrating a detail of this embodiment;

FIG. 4 illustrates a preferred application;

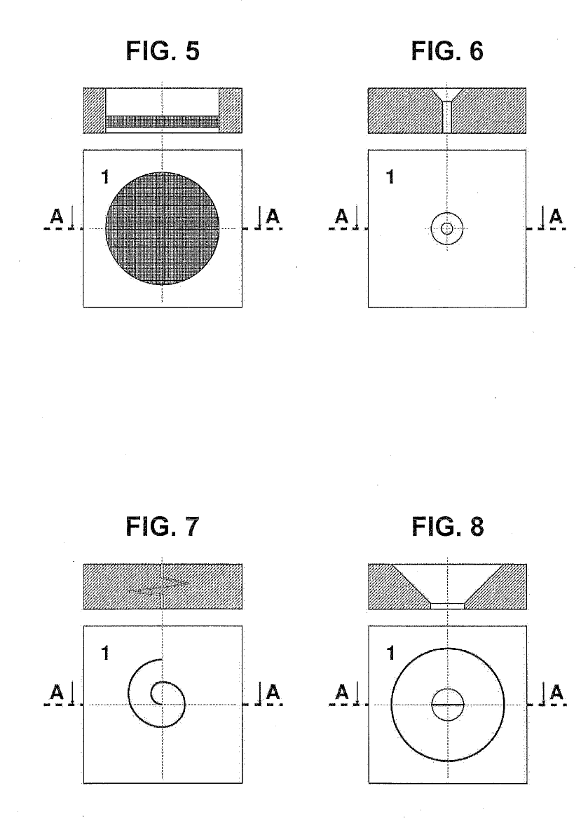

FIGS. 5 to 8 illustrate preferred interaction modules;

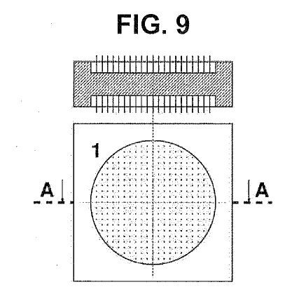

FIG. 9 illustrates a preferred cleaning module.

Firstly; it should be pointed out that the same parts described in the different embodiments are denoted by the same reference numbers and the same component names and the disclosures made throughout the description can be transposed in terms of meaning to same parts bearing the same reference numbers or same component names. Furthermore, the positions chosen for the purposes of the description, such as top, bottom, side, etc., relate to the drawing specifically being described and can be transposed in terms of meaning to a new position when another position is being described.

In the drawings, only some of the interaction modules are indicated by reference number (1). Some interaction modules are expressly not provided with reference numbers because this would otherwise make for less clarity.

FIG. 1 is a side view schematically illustrating a preferred embodiment. The interaction modules 1 are disposed one above the other in the application unit and can be dispensed in a downward direction to an exchange system 3. The exchange system is a rail 3 with a driving mechanism 6 for example, the lateral guide of which is denoted by reference (3). In the drawing, the device is mounted on a unit for testing molten plastics for example, which starts on the right-hand side with the angled inlets and on the left-hand side extends out beyond the inventive embodiment. The measuring area lies behind the circular plate with four screws.

After the measurement, the used interaction modules are fed away from the measuring point by the dispensing system 4 and are then available for subsequent analysis.

FIG. 2 is a side view illustrating a section through this embodiment. The path of the interaction modules 1 through the device and how they are stored in the application unit 2 are clear to see in this view. The driving mechanism 6, which is a ram in this instance, pushes the interaction modules 1 forward on the rail of the exchange system 3, the bottom region of which is denoted by reference (3). Whenever the ram is retracted and is no longer positioned underneath the outlet of the application unit, a new interaction module 1 drops down onto the rail 3 of the exchange system.

The interaction modules are fed one after the other to the measurement position 5 denoted by (1/5), where they can be used to take measurements, e.g. as screens for a filter pressure test, during which a molten plastic is pressed via what in this instance is a conical opening though the interaction module 1 and the pressure in the opening is measured. In particular, it is preferable to provide a unit which presses the interaction module firmly against the opening at this point to prevent any material from escaping.

The used interaction modules 1 are pushed onwards and tip into the dispensing system 4 which is similar to a chute in terms of shape and function. Due to gravitational force, the interaction modules 1 slide downwards and at the end of the dispensing system 4 (not illustrated here) can be collected or fed away by separate units, for example.

Interaction modules may also be actively removed by means of a robot arm and actively directed to other apparatus for analysis, e.g. an oven for ashing by means of a controller programmed accordingly.

FIG. 3 illustrates in greater detail how the interaction modules 1 are guided as explained above.

FIG. 4 illustrates a preferred application. The device together with a filter pressure test assembly is mounted upstream of an autosampler in this instance. The application unit 2 and dispensing system 4 are clearly illustrated.

FIGS. 5 to 8 illustrate preferred interaction modules. The bottom part of the drawing shows a plan view of the relevant module in each case and the top part shows a side view along section A-A.

FIG. 5 illustrates an interaction module 1 with a circular screen or filter, such as might be used for a filter pressure test, for example.

FIG. 6 illustrates an interaction module 1 with a vertical capillary, such as might be used to measure the viscoelastic behavior of a fluid, for example.

FIG. 7 illustrates an interaction module 1 with a spiral-shaped capillary, such as might be used for measuring the viscoelastic behavior of a fluid when a longer flow path is needed, for example.

FIG. 8 illustrates an interaction module 1 with a slotted nozzle, such as might be used for taking optical measurements, for example.

FIG. 9 illustrates a preferred cleaning module. It has a circular surface at the top and underneath is provided with cleaning brushes, for example made from metal. These brushes are able to clean along the route taken by the interaction modules through the device as the cleaning module is moved through the device.

The embodiments illustrated as examples represent possible variants of the device, and it should be pointed out at this stage that the invention is not specifically limited to the variants specifically illustrated, and instead the individual variants may be used in different combinations with one another and these possible variations lie within the reach of the person skilled in this technical field given the disclosed technical teaching.

Furthermore, individual features or combinations of features from the different embodiments illustrated and described may be construed as independent inventive solutions or solutions proposed by the invention in their own right.

The objective underlying the independent inventive solutions may be found in the description.

All the figures relating to ranges of values in the description should be construed as meaning that they include any and all part-ranges, in which case, for example, the range of 1 to 10 should be understood as including all part-ranges starting from the lower limit of 1 to the upper limit of 10, i.e. all part-ranges starting with a lower limit of 1 or more and ending with an upper limit of 10 or less, e.g. 1 to 1.7, or 3.2 to 8.1 or 5.5 to 10.

Above all, the individual embodiments of the subject matter illustrated in the drawings constitute independent solutions proposed by the invention in their own right. The objectives and associated solutions proposed by the invention may be found in the detailed descriptions of these drawings.

For the sake of good order, finally, it should be pointed out that, in order to provide a clearer understanding of the structure of the device, it and its constituent parts are illustrated to a certain extent out of scale and/or on an enlarged scale and/or on a reduced scale.

### LIST OF REFERENCE NUMBERS

1 Interaction module
2 Application unit
3 Rail
4 Dispensing system
5 Measurement position
6 Driving mechanism

1. Device for testing materials, wherein the device comprises application units (2) for interaction modules (1) and an exchange system for interaction modules, and the device is designed such that the application units (2) automatically feed interaction modules (1) to the exchange system after a control signal and the exchange system is designed to feed the interaction modules to the measuring area.

2. Device according to claim 1, wherein the device further comprises a dispensing system for used interaction modules and the exchange system is further configured to feed used interaction modules to the dispensing system after a measurement, and the dispensing system preferably further comprises at least one storage unit for storing the dispensed interaction modules.

3. Device according to claim 1, wherein the device comprises sensors and/or comprises interaction modules and in particular these interaction modules in turn comprise sensors, by means of which measurements can be taken, preferred sensors being chemical indicators or electric sensors, in particular co-operating with a power source and a data memory or elements used for wireless data transmission.

4. Device according to claim 1, wherein it comprises a control unit which automatically knows which measurement task is about to be performed, feeds the interaction module to the corresponding measuring area and generates and exports an address or code for a data memory.

5. Device according to claim 1, wherein the device further comprises a device for testing fluids comprising a fluid inlet and at least two, preferably three or more, fluid outlets, and each of these fluid outlets can be separately connected to the fluid inlet via a multi-way valve which is capable of assuming at least two functionally different positions so that the fluid flows into one of the fluid outlets respectively depending on the position of the multi-way valve.

6. Device according to claim 1, wherein the interaction modules are dispensed in a controlled manner by means of controlled closing or dispensing mechanism, and in particular an application unit is a bottomless container in which the interaction modules are disposed one above the other, and which is mounted above the exchange system so that interaction modules easily drop onto the exchange system.

7. Device according to claim 1, wherein the application units are configured to accommodate magazines in which several interaction modules may be disposed, and in particular these magazines are of a design similar to that of slide magazines, and the magazines are preferably already fixedly mounted in the device or constitute a storage device for the application units.

8. Device according to claim 1, wherein the exchange system comprises a holder structure for holding the interaction modules and a motion control system, in particular a ram or a rotating mechanism, for moving the interaction modules, and the device preferably comprises a control unit for controlling the exchange system, and the exchange system is configured in particular to move a belt or a rail containing the interaction modules, in particular linearly and/or in a circular motion.

9. Device according to claim 1, wherein it is configured to dispense individual application units in a defined order so that, depending on the application, an interaction module from one application unit is introduced into the exchange system first of all followed by an interaction module from another application unit.

10. Device according to claim 1, wherein the device is configured so that the application units can be changed during operation, and in particular the device further comprises a motion control system for the application units which is configured to enable the application units to be moved from one position to another.

11. Device according to claim 1, wherein it comprises a marker unit and is configured to automatically identify the interaction modules and/or the application units, in particular by means of characters, barcodes, RFID elements, engraving or other patterns, and in particular the device is also configured so that the markings can be scanned by means of a scanner element and a computer unit equipped with user software, the latter two being contained in the device in particular, and the position and/or function of the interaction modules and/or the application units in the device is ascertained on the basis of this scanned information or is stored as data.

12. Device according to claim 1, wherein the device comprises a sealing unit which is configured to provide a seal between the interaction module and the measuring area, and the interaction modules are moved into the measuring position by means of a lifting or screwing motion onto the housing wall of the device where they are held firmly pressed, or it is not the interaction modules which is moved but rather the sealing unit.

13. Device according to claim 1, wherein it comprises at least two interaction modules, each having a different structure and each of which is configured to take different measurements, preferred interaction modules being interaction modules containing a filter and/or a screen for a filter pressure test, interaction modules having a capillary for measuring the viscoelastic behavior of a fluid or interaction modules having a slot-shaped opening for producing a film sample for optical measurements.

14. Device according to claim 1, wherein the device is designed so that it is not the entire material flow that is measured and instead, a part of the material flow is branched off and measured, and this part is then preferably returned to the material flow.

15. Device according to claim 1, wherein the device further comprises cleaning modules which are intermingled with the interaction modules or disposed in a separate application unit, and the cleaning modules are designed in particular so that the region of the interaction modules used for measuring purposes or the entire open cross-section is filled with a cleaning material so that any impurities can be removed by the sliding movement of the cleaning module through the device, and the cleaning materials comprise in particular brushes, blades, scrapers, preferably made from metals, alloys, steel, plastics, fabrics, fleece, wood, glass or other materials.

16. Device according to claim 1, wherein the device comprises an interaction module which is configured to measure the flow properties of a material in order to determine both viscous and elastic flow behavior, and the relevant interaction modules have at least one capillary in particular which is straight or curved or spiral-shaped in particular, and in particular the device is configured to impart a mechanical vibrating motion to the capillary and measure the loss modulus the vibrations in particular.

17. Device according to claim 1, wherein the device comprises a tempering system which is configured to pre-heat the interaction modules upstream of the measuring area and/or provide cooling downstream of the measurement operation, and the interaction modules are preferably cooled after being ejected.

18. Interaction module for use in a device according to claim 1, wherein the interaction modules comprise a support and a measuring part which is held and optionally stabilized by this support, and the support is a part produced by injection casting, and the measuring part is preferably fixed to the support during the manufacturing process by casting or welding, and in particular the materials for the measuring part are placed in a half-piece of the support and then back-injected.

19. Interaction module according to claim 1, wherein the interaction module comprises structures and/or recesses extending out from its side walls which are designed to positively fit in structures formed in an application unit and/or the exchange system for guiding purposes to ensure a reliable and exact guiding action for the interaction modules in the device.

20. Interaction module according to claim 1, wherein the support and/or the measuring part are made from materials from the group including plastics, metal, ceramic, composite materials or combinations of these materials, in particular by means of milling, casting or sintering, and the interaction module preferably comprises a number of different regions suitable for taking measurements.

21. Method for testing materials with a device according to claim 1, comprising the steps:
storing a plurality of interaction modules in an application unit,
dispensing the interaction modules from the application unit to an exchange system,
feeding the dispensed interaction modules to a measurement position by means of the exchange system,
feeding the used interaction modules away after taking the measurement by means of the measuring system.
